(19) United States
(12) Patent Application Publication
(10) Pub. No.: US 2026/0326678 A1
(43) Pub. Date: Oct. 22, 2026

(54) SYSTEM FOR THREE-IN-ONE RV FLAG POLE AND ANTENNA MOUNTING

(71) Applicant: Donald Chin, Ontario, CA (US)

(72) Inventor: Donald Chin, Ontario, CA (US)

(21) Appl. No.: 19/181,645

(22) Filed: Apr. 17, 2025

(51) Int. Cl. B60R 9/06; F16M 13/02; H01Q 1/12

(52) U.S. Cl. CPC B60R 9/06; F16M 13/022; F16M 2200/066; H01Q 1/12

(57) ABSTRACT

An accessory mounting bracket system for recreational vehicles (RVs) addresses the challenge of diverse RV configurations by providing a versatile solution for mounting flag poles and antennas. The system includes a cylindrical tube for receiving the accessory, an orthogonally joined attachment arm, a receiver slidably connected to the attachment arm, a receiver plate joined to the receiver, and a mounting plate mated to the receiver plate. This mounting system mounts to multiple RV components, including bumpers, hitch receivers, or A-frames.

### BACKGROUND OF THE INVENTION

The present invention relates to recreational vehicle accessory mounting systems and, more particularly, to versatile mounting brackets for flag poles and antennas adaptable to various RV configurations.

In the realm of recreational vehicles (RVs), the ability to mount accessories such as flag poles and antennas (e.g., Starlink® or Citizens Band [CB] radio) is a common requirement for many users. However, the current market offerings present significant limitations. One significant challenge is the diversity in RV designs, which can vary widely in terms of available mounting locations and structural features. This diversity necessitates the development of mounting systems that are both versatile and compatible compatible with a wide range of RV models. Additionally, consumers typically must purchase multiple mounting brackets, each designed for a specific part of the RV, such as the bumper, hitch, or frame. This increases the cost and also complicates the installation process, as users need to determine which bracket is suitable for their specific RV configuration.

Existing products in the market generally offer only a single installation method, which restricts the flexibility and adaptability needed by RV users. These systems are often tailored for particular parts of the RV, such as the bumper or hitch, and do not accommodate the diverse configurations found in various RV models. For instance, when camping, users often reposition their flag poles or antennas due to changes in parking positions or to optimize signal reception. The lack of a versatile mounting solution means that users are often forced to purchase additional equipment or make do with suboptimal setups, which can be both inconvenient and inefficient.

As can be seen, there is a need for a comprehensive mounting option that can be easily adapted to various RV configurations without obtaining multiple mounts.

### SUMMARY OF THE INVENTION

In one aspect of the present invention, the disclosure includes an accessory mounting bracket system for recreational vehicles, comprising a cylindrical tube configured to receive the accessory; an attachment arm orthogonally joined to the cylindrical tube; a receiver slidably connected to the attachment arm; a receiver plate joined to the receiver, wherein the receiver extends perpendicularly to the receiver plate; and a mounting plate mated to the receiver plate.

In another aspect of the present invention, the cylindrical tube is made of a corrosion-resistant material selected from the group consisting of stainless steel and aluminum. In a further embodiment, the attachment arm is telescopically adjustable with respect to the receiver. Additionally, the receiver plate is secured to the mounting plate with fastening hardware. The attachment arm and the receiver plate each have formed therein aligned bores configured to receive locking pins.

In a third aspect of the present invention, the disclosure includes a method for mounting an accessory on a recreational vehicle, comprising providing the accessory mounting bracket system. These and other features will be more clearly understood from the following detailed description taken in conjunction with the accompanying drawings and claims.

The present technology addresses these challenges by providing a comprehensive solution that allows for multiple installation options. This three-in-one mounting bracket is designed to be compatible with various RV configurations, including those with or without bumpers, hitch receivers, or A-frames. By offering a single product that can be adapted to different mounting locations, the technology simplifies the process for users, reduces multiple purchases, and enhances the overall user experience. This innovative approach mounts to diverse RV configurations and also ensures that the mounting solution remains relevant even if the RV is replaced or reconfigured in the future.

These and other features, aspects and advantages of the present invention will become better understood with reference to the following drawings, description, and claims.

### BRIEF DESCRIPTION OF THE DRAWINGS

FIG. 1 is a perspective view of a three-in-one RV flag pole and antenna mounting bracket according to an embodiment of the present invention, shown in use;

FIG. 2 is a detail view thereof;

FIG. 3 is an exploded view thereof;

FIG. 4 is another detail view thereof, shown in use; and

FIG. 5 is a perspective view of a three-in-one RV flag pole and antenna mounting bracket according to another embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a three-in-one RV flag pole and antenna mounting bracket system, generally comprising a hitch mount, an extension arm, and a bumper or frame mounting plate.

The hitch mount may comprise a cylindrical pole-holding tube and an attachment arm.

The extension arm may include a receiver tube joined to a receiver plate and extending normal thereto.

The mounting plate may be a substantially square plate with bores formed therethrough. The bores may be configured to have identical locations to bores formed in the receiver plate.

Attachment hardware may be selected, for example, from the group consisting of hand-tightened bolts, D-ring pins, nuts, bolts, washers, lock washers, and any combination thereof.

The tube may be lined, for example with polyvinyl chloride (PVC).

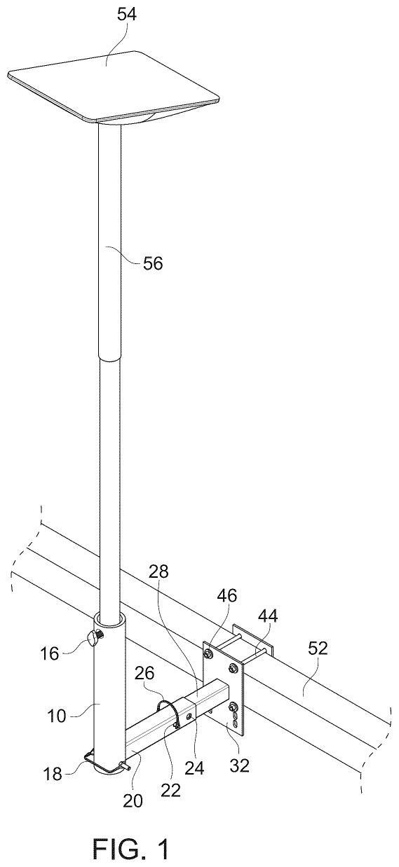

Referring to FIGS. 1-5, FIG. 1 shows a three-in-one RV flag pole and antenna mounting bracket system according to an embodiment of the present invention. The system is designed to provide a versatile mounting solution for RVs, allowing for the attachment of both flag poles and antennas. A cylindrical pole-holding tube 10 is configured to securely hold a pole 56. The tube 10 is positioned vertically and provides stability and support for the pole 56. The tube 10 is connected to an attachment arm 20, which extends horizontally to provide additional structural support. A set screw or knob stud 16 is used to secure the pole 56 within the tube 10. By tightening the set screw 16, the pole 56 is held firmly in place, preventing any unwanted movement or dislodgement, particularly in windy conditions. The horizontal attachment arm 20 connects the pole-holding tube 10 to a mountable straight receiver (MSR) 28. The attachment arm 20 may slidably accommodate the straight receiver 28. The attachment arm includes small pin holes (SPH) 22 and large pin holes (LPH) 24. A large clevis pin with retainer wire (LCP) 18 is inserted through the attachment arm 20 and the tube 10, allowing for easy assembly and disassembly of the mounting system. The retainer wire ensures that the LCP 18 remains in place during use. A small clevis pin with retainer wire (SCP) 26 is used in conjunction with the small pin holes (SPH) 22 on the attachment arm 20. This pin 26 provides additional security and stability to the mounting system, ensuring that all components remain properly aligned and connected during use. The mountable straight receiver (MSR) 28 is a square tube that serves as the main mounting interface for the system. The MSR 28 is attached to a receiver rear plate (RRP) 32, e.g., by welding. Bolts 44 and nuts 46 ensure that the mounting system remains firmly attached to a bumper 52 of an RV, providing a reliable and stable platform for the pole 56 and an antenna 54. The RRP 32 distributes the load to prevent damage to the RV's bumper 52. The antenna 54 is mounted on top of the pole 56, allowing the antenna 54 to be positioned at an optimal height for signal reception. This configuration ensures that the antenna 54 can be easily adjusted and repositioned.

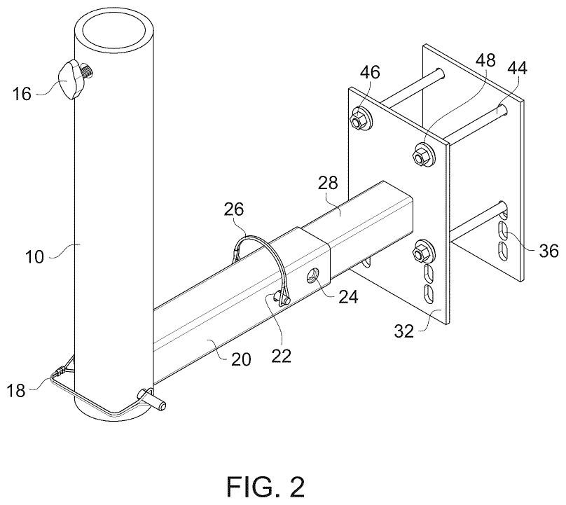

A detailed view of the three-in-one RV flag pole and antenna mounting bracket system is shown in FIG. 2, illustrating lower bolt slots (LBS) 36 formed in the receiver rear plate (RRP) 32, which allow for adjustable positioning of the mounting system. The LBS 36 enable the user to fine-tune the alignment and fit of the RRP 32 against the RV's bumper or other mounting surfaces. This adjustability ensures that the mounting system can accommodate various RV configurations, providing a secure and stable attachment. The bolts 44, nuts 46, and washers 48 work in conjunction with the slots 36 to fasten the RRP 32 in the desired position, enhancing the overall versatility and adaptability of the mounting system.

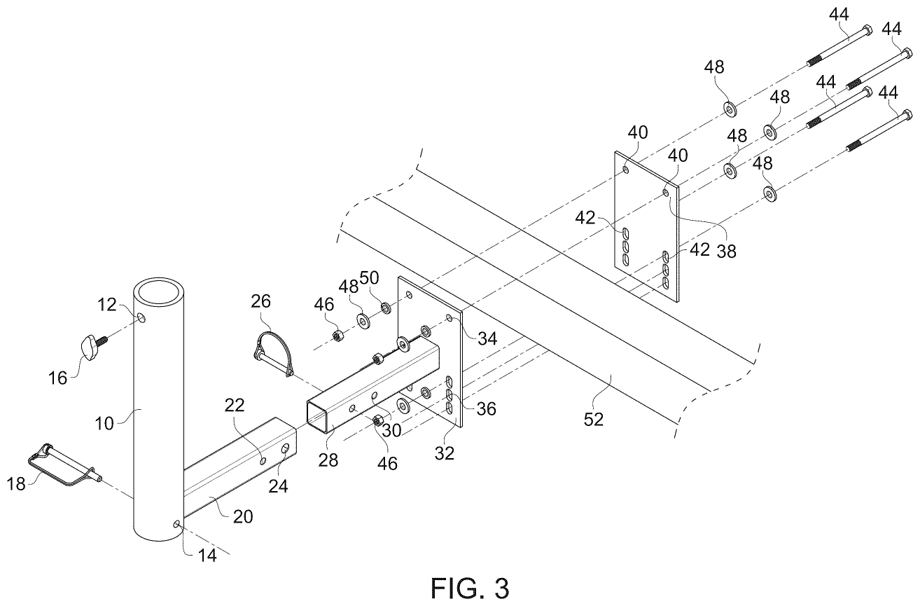

FIG. 3 illustrates an exploded view of the three-in-one RV flag pole and antenna mounting bracket system, highlighting the assembly of its components. The pole-holding tube 10 features an upper tube hole (UTH) 12 for securing the pole with a set screw 16, and a lower tube hole (LTH) 14 that allows for additional adjustability and secure alignment of the pole. The attachment arm 20, with small pin holes (SPH) 22 and large pin holes (LPH) 24, connects to the pole 10 using clevis pins (18 and 26). The mountable straight receiver (MSR) 28 is attached to the receiver rear plate (RRP) 32, which includes upper bolt holes (UBH) 34, lower bolt slots (LBS) 36, and receiver pin holes 30 for securing the MSR 28 to the RRP 32, allowing for adjustable positioning on the bumper 52. A rear mounting plate (RMP) 38 provides additional support and load distribution, featuring upper bolt holes (UBH) 40 and lower bolt slots (LBS) 42 formed therein. These features enable secure attachment and alignment with the RRP 32, enhancing the stability of the mounting system. The assembly is secured with bolts 44, nuts 46, washers 48, and lock washers 50. This view demonstrates the interconnection and functionality of each component.

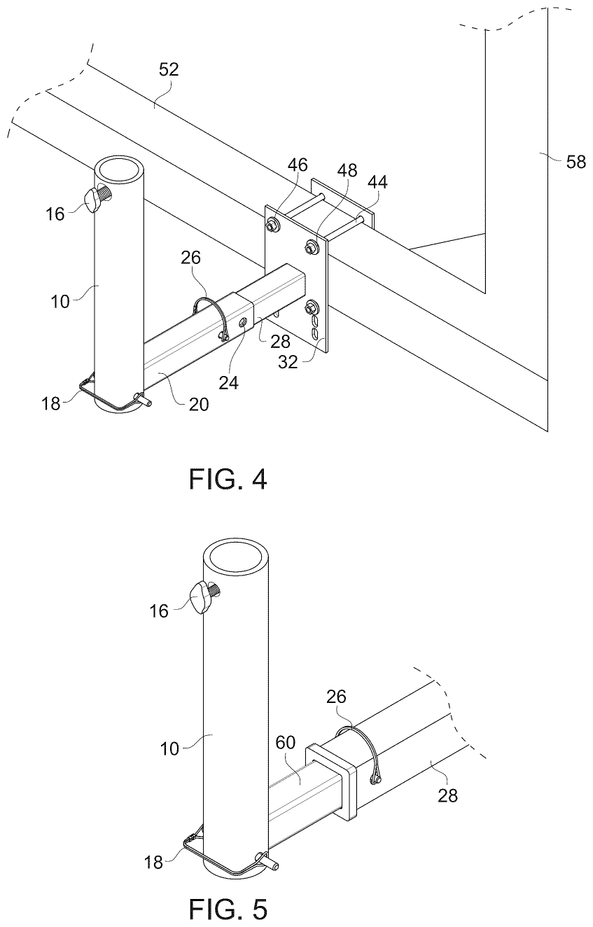

As shown in FIG. 4, the system may be clamped to the bumper 52 of an A-frame hitch.

In some embodiments, as FIG. 5 illustrates, the attachment arm 60 may be configured to slidably insert into the straight receiver 28.

It should be understood, of course, that the foregoing relates to exemplary embodiments of the invention and that modifications may be made without departing from the spirit and scope of the invention as set forth in the following claims.

What is claimed is:

1. An accessory mounting bracket system for recreational vehicles, comprising:
a cylindrical tube configured to receive an accessory;
an attachment arm orthogonally joined to the cylindrical tube;
a receiver slidably connected to the attachment arm;
a receiver plate joined to the receiver, wherein the receiver extends normal to the receiver plate; and
a mounting plate mated to the receiver plate.

2. The accessory mounting bracket system of claim 1, wherein the cylindrical tube is made of a corrosion-resistant material selected from the group consisting of stainless steel and aluminum.

3. The accessory mounting bracket system of claim 1, wherein the attachment arm is telescopically adjustable with respect to the receiver.

4. The accessory mounting bracket system of claim 1, wherein the receiver plate is secured to the mounting plate with fastening hardware.

5. The accessory mounting bracket system of claim 1, wherein the attachment arm and the receiver plate each have formed therein aligned bores configured to receive locking pins.

6. A method for mounting an accessory on a recreational vehicle, comprising:
providing the accessory mounting bracket of claim 1;
mounting the accessory mounting bracket to a mounting surface selected from the group consisting of a front frame, a bumper, and a hitch receiver;
adjusting the attachment arm relative to the mounting surface by telescopically sliding the attachment arm along the receiver;
securing the accessory mounting bracket to the mounting surface with fastening hardware;
installing the accessory into the cylindrical tube; and
securing the accessory within the cylindrical tube with fastening hardware.
